(19) United States
(12) Patent Application Publication
(10) Pub. No.: US 2012/0015541 A1
(43) Pub. Date: Jan. 19, 2012

(54) SELF-SECURING POWER CORD

(75) Inventor: Hsing Lu, Fremont, CA (US)

(73) Assignee: JUNIPER NETWORKS, INC., Sunnyvale, CA (US)

(21) Appl. No.: 12/837,298

(22) Filed: Jul. 15, 2010

(51) Int. Cl. H01R 13/62

(52) U.S. Cl. 439/345

(57) ABSTRACT

An alternating current (AC) power cord retainer is configured to be incorporated into or connected to a power cord, instead of the electronic device to which the cord may be connected. The power cord retainer is configured to be received within and engage the same receptacle within which the plug of the power cord is received.

### TECHNICAL FIELD

The invention relates to power cords for electronic devices.

### BACKGROUND

Critical to the proper operation of an electronics system is for the electrical power cord that supplies power to remain connected to the electronics housing. Inadvertent disconnection from the electronics housing can cause system failure. For storage systems, the loss of power can result in data loss and downtime. Notwithstanding, many power cords do not have built-in retention features. Previous efforts to devise a power cord retention mechanism have used a clip or a flange attached to the electronic device with features designed to grasp and hold a specific style of power cord plugged into the device.

Power cords, however, are generally available in a variety of styles, often determined by the “overmold” of the power cord. The overmold is a transitional plastic or rubber region located between the cord and the receptacle end of the power cord. The use of the overmold is for embedding the wire connections and for providing strain-relief. Because no industry standard governs the size or shape of the overmold, different vendors have produced a variety of differently shaped and sized overmolds. Consequently, a power cord retention mechanism designed for one style of power cord may be inadequate or of no use for another style of power cord.

### SUMMARY

In general, examples according to this disclosure are directed to power cord retention techniques for securing AC power cords in receptacles in, e.g., electronic devices. In one example, a power cord for connecting an alternating current (AC) power source to an electronic device includes a plug, a cable, and a retainer. The plug is configured to be received by a receptacle. The cable is connected to the plug. The retainer is connected to at least one of the cable or the plug and includes at least one tab configured to be received by and engage the receptacle to secure the plug in the receptacle.

In another example, a system includes an electronic device, a power cord, and a retainer. The power cord is for connecting an alternating current (AC) power source to the electronic device. The power cord includes a plug and a cable. The plug is configured to be received by a receptacle in the electronic device. The cable is connected to the plug. The retainer is connected to at least one of the cable or the plug and includes at least one tab configured to be received by and engage the receptacle to secure the plug in the receptacle.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a perspective view of an alternating current (AC) power cord received within a receptacle in an electronic device.

FIG. 2 is an elevation side view of the AC power cord and electronic device of FIG. 1.

FIGS. 3A-C are orthogonal views of an example AC power cord retainer.

FIGS. 4A-C are orthogonal views of another example AC power cord retainer.

FIGS. 5A and 5B are perspective views of an AC power cord including additional example AC power cord retainers.

FIG. 6 is a plan view of an AC power cord including an example power cord retainer and identification cuff.

### DETAILED DESCRIPTION

The following examples are directed to power cord retention techniques for securing AC power cords in receptacles in, e.g., electronic devices. The disclosed power cord retainers are configured to be incorporated into or connected to a power cord, instead of the electronic device to which the cord may be connected. Additionally, the example power cord retainers are configured to be received within and engage the same receptacle within which the plug of the power cord is received. The disclosed retainers are “self-securing,” because the retainers are configured to automatically secure a power cord once the plug of the cord is received within a receptacle of an electronic device to which the cord is connected.

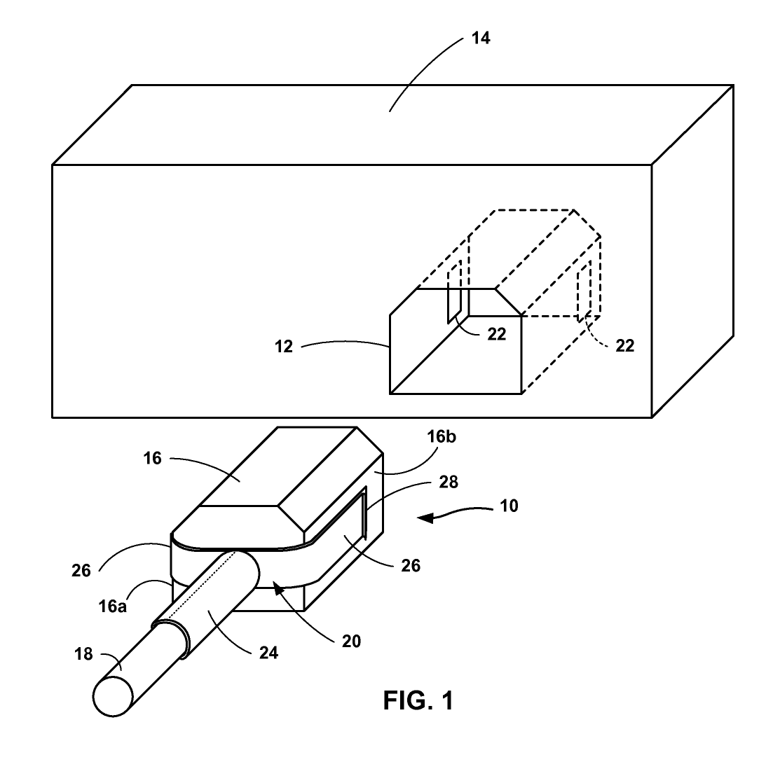

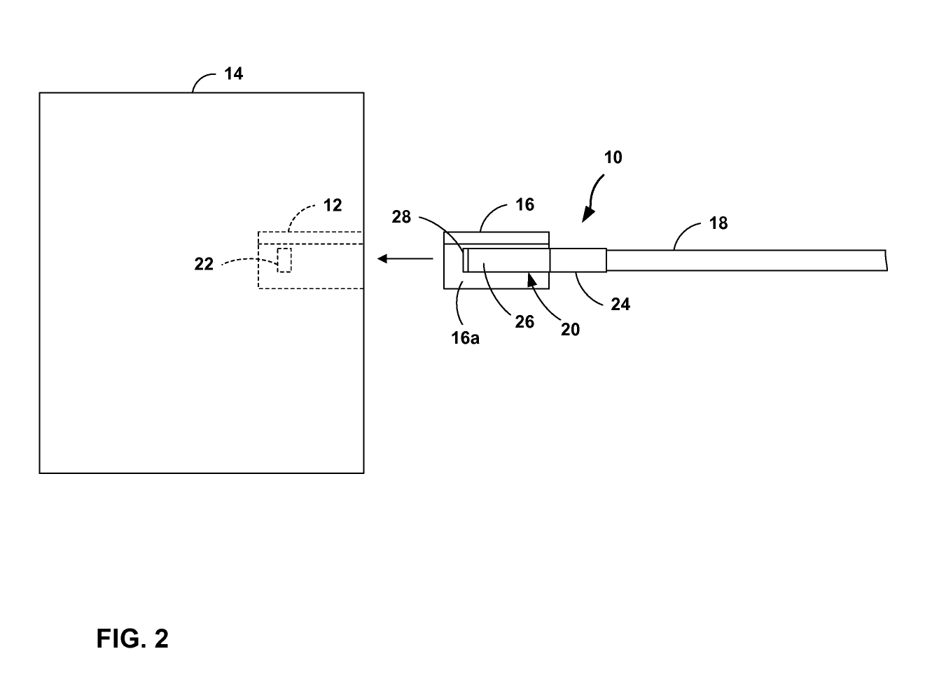

FIG. 1 is a perspective view of AC power cord 10 configured to be received within receptacle 12 in electronic device 14. FIG. 2 is an elevation side view of AC power cord 10 configured to be received within receptacle 12 in electronic device 14. Power cord 10 includes plug 16, cable 18, and retainer 20. Receptacle 12 in electronic device 14 includes apertures 22. In FIGS. 1 and 2, plug 16 and retainer 20 are configured to be received within receptacle 12 in electronic device 14. Retainer 20 is configured to engage receptacle 12 to securely connect plug 16, and, thereby, power cord 10 to electronic device 14.

In the example of FIGS. 1 and 2, retainer 20 includes sleeve 24 connected to two tabs 26. Sleeve 24 is configured to receive cable 18 of power cord 10 and thereby connect retainer 20 to the power cord. Two tabs 26 are arranged along two generally opposing sides of plug 16. In the view of the example of FIGS. 1 and 2, tabs 26 are arranged along two sides 16a, 16b of plug 16. However, in another example, two tabs 26 may be arranged along, e.g., the top and bottom of plug 16. Ends 28 of tabs 26 protruding away from cable 18 and toward receptacle 12 in electronic device 14 are, in the example of FIGS. 1 and 2, barbed to engage apertures 22 in receptacle 12 and catch on an edge of the apertures to securely connect plug 16 to electronic device 14. Although the example of FIGS. 1 and 2 includes receptacle 12 with apertures 22, in another example, the receptacle includes depressions in the side walls of the receptacle that are configured to be engaged by protrusions on tabs 26 of retainer 20, e.g. by barbed ends 28 of the retainer.

FIGS. 1 and 2 are schematic diagrams of an electronic system including an AC power cord and, as such, are meant for illustrative purposes only. For example, some details may be omitted from FIGS. 1 and 2 that are common to such systems. In one example, plug 16 and/or receptacle 12 include prongs connected to the positive, negative, and ground wires that form the mechanism by which power is transmitted from a power source to electronic device 14. The wire prongs may be included in plug 16, e.g. protruding from the end of the plug toward receptacle 12. In another example, the wire prongs are included in receptacle 12 in electronic device 14, e.g. protruding from inner surface 12a of the receptacle toward plug 16.

Additionally, in FIGS. 1 and 2, plug 16 is represented as an overmolded cable mount female connector generally shaped in accordance with the C13 type connector defined by International Electrotechnical Commission (IEC) specification 60320. Receptacle 12 is configured to receive plug 16, and, as such, is representative of the C14 type panel mounted mail connector defined by IEC 60320 in the example of FIGS. 1 and 2. However, in other examples, plug 16 and receptacle 12 may differ. For example, AC power cord retention examples according to this disclosure include C17 type cable mounted female plugs as defined by IEC 60320, in which the plug and cable, instead of being arranged in a line, are arranged generally perpendicular to one another. In such an example, a C18 type chassis mount male receptacle may be employed. In any event, examples according to this disclosure include a variety of different types of power cords and corresponding receptacle configurations, in which a power cord retainer is connected to the cord and configured to be received within and engage a receptacle to securely connect the cord to an electronic device.

In the example of FIGS. 1 and 2, electronic device 14 is illustrated schematically. Electronic device 14 may be any kind of device that requires AC power and to which an AC power cord may be connected for transmitting such power from a source to the device. In one example, electronic device 14 is a networking device, including, e.g., a router, switch, gateway, load balancing appliance, Virtual Private Networking appliance, or another type of networking device. In some examples, such networking devices are mounted in racks in an array of a number of devices, each of which may include its own AC power cord. Securing the power cords against unexpected disconnection from the network devices may be especially important in such applications, where the devices may be expected to be operating most or all day, most or all days of the year.

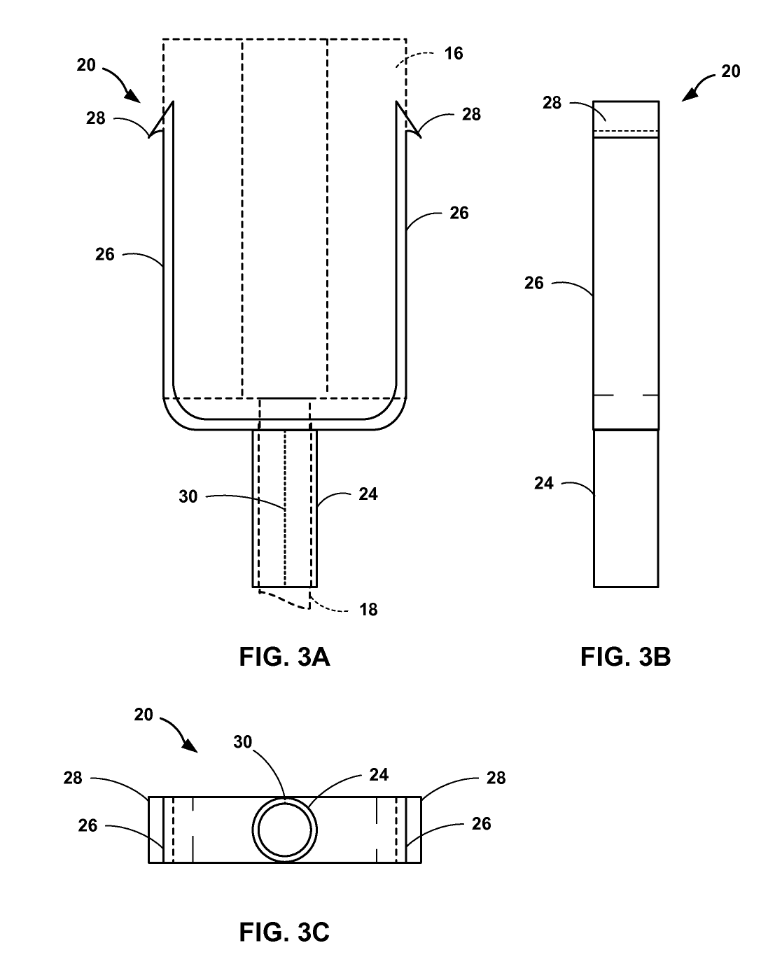

FIGS. 3A-C are orthogonal views of AC power cord retainer 20. FIG. 3A is a plan view of power cord retainer 20 including power cord 10 shown in phantom line to illustrate the arrangement of the retainer with respect to the cord. FIGS. 3B and 3C are side and bottom elevation views, respectively, of power cord retainer 20. Retainer 20 includes sleeve 24 connected to two tabs 26, each of which includes barbed end 28. As illustrated in FIG. 3A, sleeve 24 is configured to receive cable 18 of power cord 10 and thereby connect retainer 20 to the power cord. In the example of FIGS. 3A-3C, sleeve 24 of power cord retainer 20 includes seam 30. In one example, power cord retainer 20 is removably connectable to power cord 10 by separating sleeve 24 at seam 30 to enable the sleeve to receive cable 18 of the power cord. Seam 30 may have a number of different configurations to enable power cord retainer 20 to be removably connectable to power cord 10. In one example, sleeve 24 is fabricated from a resilient material and seam 30 includes a generally smooth edge cut through sleeve 24. When sleeve 24 is separated at seam 30 to receive cable 18, the material of the sleeve may be deformed to open at the seam and then be released to close at the seam and thereby secure the cable within the sleeve. In one example, seam 30 includes edge features to assist in securing the seam together after cable 28 has been received within sleeve 24. For example, one edge of seam 30 may include a number of tabs protruding toward the other edge of the seam, which may include a corresponding number of slots configured to receive the tabs when the seam is closed.

In another example, instead of retainer 20 being removably connectable to power cord 10, retainer 20 is fabricated integral with the power cord. For example, retainer 20 may be formed as a part of the overmold of plug 16 of power cord 10. In one example, plug 16 and retainer 20 are formed by injection molding. In another example, retainer 20 is pre-assembled with power cord 10. For example, sleeve 24 of retainer 20 may receive cable 18 of cord 10 via seam 30. However, after assembling retainer 20 to cord 10, seam 30 of sleeve 24 may be sealed closed by joining the edges of the seam to one another, e.g., using an adhesive or some other appropriate fastener. In some examples, a sleeve may be unnecessary to secure the retainer with respect to the power cord. For example, retainer 20 may include one or more tabs 26, which may be molded or otherwise fabricated integral with plug 16 of power cord 10 without the need for a sleeve to receive cable 18 of the cord.

Referring to FIGS. 1-3C, in one example, tabs 26 of retainer 20 are formed of a resilient material and are biased outward away from sides 16a, 16b of plug 16, or other sides of the plug along which the tabs are arranged. In one example, tabs 26 may be formed from a resilient plastic or rubber, e.g. the same plastic or rubber from which plug 16 is formed. In another example, tabs 26 of retainer 20 may be formed from another electrically insulative and resilient material. To secure power cord 10 to electronic device 14, an operator may pinch tabs 26 inward toward sides 16a, 16b of plug 16 and insert plug 16 into receptacle 12 in the device. After inserting plug 16 into receptacle 12 in device 14, the operator may release tabs 26, which will automatically expand out from sides 16a, 16b to allow barbed ends 28 to engage apertures 22 in the receptacle and thereby secure power cord 10 to the electronic device. In some examples, receptacle 12 is sized to receive plug 16 and, as such, may not be configured to accept the addition of tabs 26 along sides 16a, 16b of the plug. In such examples, plug 16 my include channels in sides 16a, 16b that are sized to receive tabs 26 when they are pinched toward the sides of the plug. In FIG. 3A, tabs 26 are shown schematically in a pinched or collapsed state relative to plug 16 of power cord 10. Tabs 26 are received within channels in sides 16a, 16b of plug 16 such that an outer surface of each the tabs 26 lies flush with each side of the plug. In one example, the channels in the side of plug 16 may be deep enough to receive tabs 26 such that the outer point barbed ends 26 lie flush with the sides of the plug.

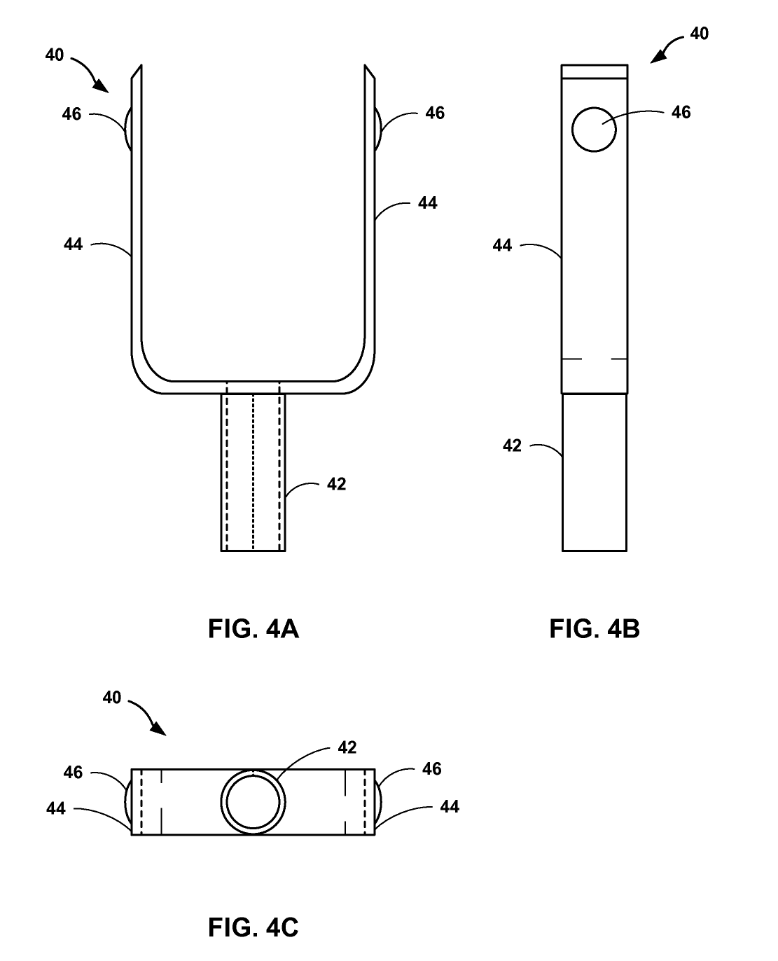

FIGS. 4A-C are orthogonal views of another example AC power cord retainer 40. FIG. 4A is a plan view of power cord retainer 40 and FIGS. 4B and 4C are side and bottom elevation views, respectively, of the power cord retainer. Power cord retainer 40 is similar to retainer 20 and includes sleeve 42 and two tabs 44, which may be configured to be arranged along two generally opposing sides of a plug of a power cord, e.g. sides 16a, 16b of plug 16 of power cord 10. However, power cord retainer 40 does not include barbed ends. Instead, power cord retainer includes bosses 46 protruding from each of tabs 44. Bosses 46 may be sized and shaped to be received by corresponding depressions or apertures in a receptacle of an electronic device to secure a power cord to the device. In the example of FIGS. 4A-4C, bosses 46 are generally circular. However, in other examples, bosses 46 may be shaped differently, including, e.g., oblong or oval shapes.

In a similar fashion to retainer 20, tabs 44 of retainer 40 may be, in one example, formed of a resilient material and biased outward away from two generally opposing of a plug, e.g. sides 16a, 16b of plug 16. In one example, tabs 44 of retainer 40 may be formed from a resilient plastic or rubber. In another example, tabs 44 may be formed from another electrically insulative and resilient material. To secure a power cord to which retainer 40 is connected to an electronic device, an operator may pinch tabs 44 inward toward the sides of the plug of the cord and insert the plug into a receptacle in the device. After inserting the plug and tabs 44 of retainer 40 into the receptacle in the device, the operator may release the tabs, which will automatically expand out from the sides of the plug to allow bosses 46 to engage depressions or apertures in the receptacle and thereby secure the power cord to the electronic device.

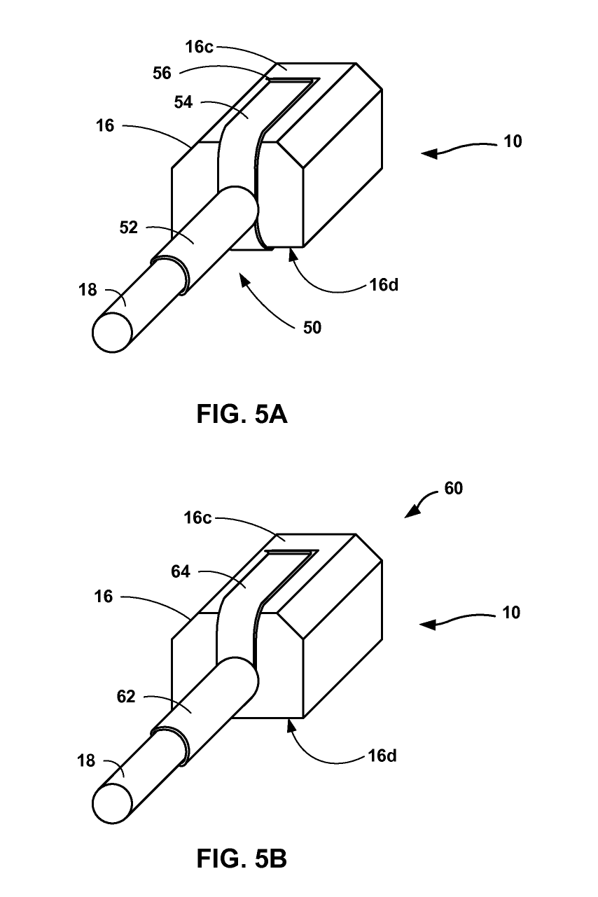

FIGS. 5A and 5B are perspective views of AC power cord 10 including additional example AC power cord retainers 50 and 60, respectively. In FIG. 5A, retainer 50 is connected to power cord 10 by sleeve 52 receiving cable 18 of the cord. Retainer 50 is substantially similar to retainer 20 described above and includes sleeve 52 connected to two tabs 54 (only one of which is visible in the view of FIG. 5A), each of which includes barbed ends 56 (only one of which is visible in the view of FIG. 5A). Retainer 50, in contrast to retainer 20, is connected to power cord 10 such that tabs 54 are arranged along top 16c and bottom 16d of plug 16. Retainer 50 may be employed in a similar fashion as described above with reference to retainer 20, but in conjunction with a receptacle that includes apertures or depressions in the top and bottom of the receptacle that are configured to be engaged by barbed ends 56 of tabs 54.

FIG. 5B is a perspective view of AC power cord 10 including retainer 60. Retainer 60 includes sleeve 62 connected to one tab 64. Tab 64 includes barbed end 66, which may be configured to engage an aperture or depression in a receptacle in an electronic device to secure power cord 10 to the device. In the example of FIG. 5B, tab 64 is arranged along top 16c of plug 16 of power cord 10. However, in other examples, tab 64 may be arranged along a different side of plug 16, e.g. bottom 16d or sides 16a or 16b of the plug of power cord 10. Additionally and with reference to both FIGS. 5A and 5B, although retainers 50 and 60 are illustrated with barbed ends 56 and 66, respectively, in other examples, tabs 54 and 64 of the retainers may include other protrusions, including, e.g., bosses protruding from the tabs as illustrated in the example of FIGS. 4A-C.

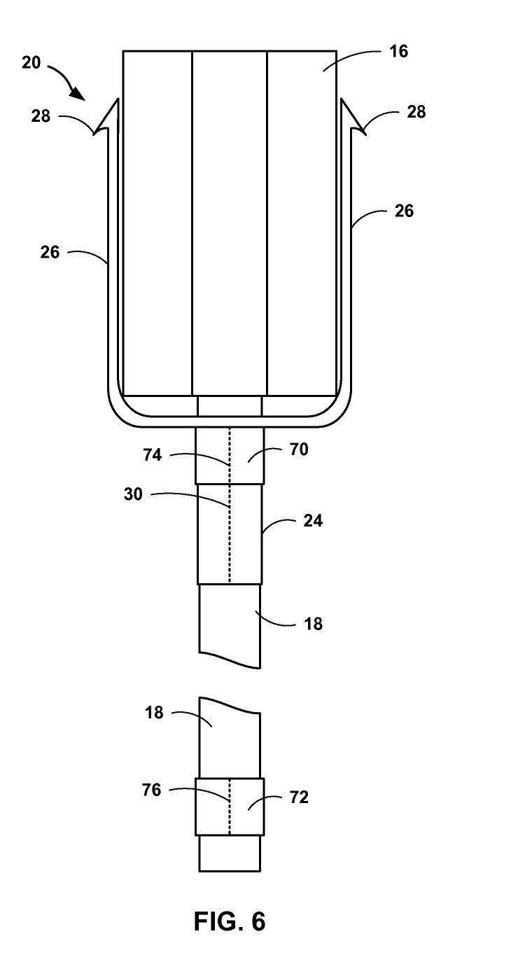

FIG. 6 is a plan view of power cord retainer 20 including power cord 10. Retainer 20 includes sleeve 24 connected to two tabs 26, each of which includes barbed end 28. As illustrated in FIG. 6, sleeve 24 is configured to receive cable 18 of power cord 10 and thereby connect retainer 20 to the power cord.

As noted above, power cord retainers according to this disclosure may be employed to secure power cords to networking devices, including, e.g., a router, switch, gateway, load balancing appliance, Virtual Private Networking appliance, or another type of networking device. Such networking devices may be mounted in racks in an array of a number of devices, each of which may include its own AC power cord. The rack mounted array of devices may form a complex and convoluted combination of various cords extending from the devices including the power cords. As such, in some examples, it may be difficult for operators to identify a power cord corresponding to a device at both ends of the cord, e.g. at the end connected to the device and the end connected to the AC power source.

The example of FIG. 6 includes two identification cuffs 70, 72, one of which is arranged at each end of power cord 10. Identification cuff 70 may include indicia that is the same as or otherwise corresponds to indicia included on identification cuff 72 such that an operator may be assisted in identifying both ends of power cord 10 in applications in which it is one of many cords arranged adjacent one another and connected to a common AC power source. In one example, each of identification cuffs 70, 72 may be formed of the same color material, e.g. a red, green, blue, or other colored plastic or rubber. In another example, identification cuffs 70, 72 may each include the same number(s), letter(s), or alphanumeric code.

In the example of FIGS. 3A-3C, identification cuffs 70, 72 include seams 74, 76, respectively. In one example, identification cuffs 70, 72 are removably connectable to power cord 10 by separating the cuffs at seams 74, 76, respectively, to enable each cuff to receive cable 18 of the power cord. In the example of FIG. 6, identification cuff 70 is removably connected to power cord 10 by separating the cuff at seams 74 to enable the cuff to receive sleeve 24 of power cord retainer 20. Seams 74, 76 may have a number of different configurations to enable identification cuffs 70, 72, respectively, to be removably connected to power cord 10. In one example, cuffs 70, 72 are fabricated from a resilient material and seams 74, 76 include a generally smooth edge cut through each of the cuffs. When cuffs 70, 72 are separated at seams 74, 76, respectively, to receive cable 18 of cord 10 or sleeve 24 of retainer 20, the material of the cuffs may be deformed to open at the seam and then be released to close at the seam and thereby secure the cable or sleeve within the cuffs. In one example, seams 74, 76 may include edge features to assist in securing the seam together after cable 18 or sleeve 24 has been received within cuffs 70, 72, respectively. For example, one edge of each of seams 74, 76 may include a number of tabs protruding toward the other edge of the seam, which may include a corresponding number of slots configured to receive the tabs when the seam is closed. In one example, sleeve 24 may include or constitute identification cuff 70 and may be coded to correspond to identification cuff 72, which may be arranged at the other end of power cord 10 from retainer 20 and plug 16.

Various embodiments of the invention have been described. These and other embodiments are within the scope of the following claims.

1. A power cord for connecting an alternating current (AC) power source to an electronic device, the power cord comprising:
a plug configured to be received by a receptacle;
a cable connected to the plug; and
a retainer connected to at least one of the cable or the plug and comprising at least one tab configured to be received by and engage the receptacle to secure the plug in the receptacle.

2. The power cord of claim 1, wherein the plug comprises an overmold and the at least one tab of the retainer is arranged along at least one side of the overmold.

3. The power cord of claim 2, wherein the at least one tab of the retainer comprises two tabs arranged along two generally opposing sides of the overmold.

4. The power cord of claim 3, wherein the retainer comprises a sleeve configured to receive the cable and wherein the two tabs of the retainer protrude from the sleeve to be arranged along the two generally opposing sides of the overmold.

5. The power cord of claim 4, wherein the sleeve comprises a colored material and further comprising a colored cuff configured to be arranged toward the end of the cable opposite the end to which the plug is arranged.

6. The power cord of claim 5, wherein the colored material of the sleeve and the colored cuff comprise the same color.

7. The power cord of claim 4, wherein the sleeve comprises a longitudinal seam configured to split the sleeve longitudinally to receive the cable.

8. The power cord of claim 2, wherein the at least one side along which the at least one tab is arranged comprises a depression configured to receive the at least one tab.

9. The power cord of claim 1, wherein the at least one tab comprises a protrusion configured to be received by at least one of an aperture or a depression in the receptacle to secure the plug in the receptacle.

10. The power cord of claim 1, wherein the protrusion comprises a barbed end of the at least one tab.

11. The power cord of claim 1, wherein the protrusion comprises a boss.

12. The power cord of claim 1 further comprising at least one identification cuff configured to receive and be secured to the cable.

13. The power cord of claim 12, wherein the at least one identification cuff comprises two colored cuffs, one of which is configured to be arranged toward the end of the cable to which the plug is connected and the other of which is configured to be arranged toward the opposite end of the cable.

14. The power cord of claim 13, wherein the two colored cuffs comprise the same color.

15. A system comprising:
an electronic device;
a power cord for connecting an alternating current (AC) power source to the electronic device, the power cord comprising:
a plug configured to be received by a receptacle in the electronic device;
a cable connected to the plug; and
a retainer connected to at least one of the cable or the plug and comprising at least one tab configured to be received by and engage the receptacle to secure the plug in the receptacle.

16. The system of claim 15, wherein the plug comprises an overmold and the at least one tab of the retainer is arranged along at least one side of the overmold.

17. The system of claim 16, wherein the at least one tab of the retainer comprises two tabs arranged along two generally opposing sides of the overmold.

18. The system of claim 17, wherein the retainer comprises a sleeve configured to receive the cable and wherein the two tabs of the retainer protrude from the sleeve to be arranged along the two generally opposing sides of the overmold.

19. The system of claim 18, wherein the sleeve comprises a colored material and further comprising a colored cuff configured to be arranged toward the end of the cable opposite the end to which the plug is arranged.

20. The system of claim 19, wherein the colored material of the sleeve and the colored cuff comprise the same color.

21. The system of claim 18, wherein the sleeve comprises a longitudinal seam configured to split the sleeve longitudinally to receive the cable.

22. The system of claim 16, wherein the at least one side along which the at least one tab is arranged comprises a depression configured to receive the at least one tab.

23. The system of claim 15, wherein the at least one tab comprises a protrusion configured to be received by at least one of an aperture or a depression in the receptacle to secure the plug in the receptacle.

24. The system of claim 15, wherein the protrusion comprises a barbed end of the at least one tab.

25. The system of claim 15, wherein the protrusion comprises a boss.

26. The system of claim 15 further comprising at least one identification cuff configured to receive and be secured to the cable.

27. The system of claim 26, wherein the at least one identification cuff comprises two colored cuffs, one of which is configured to be arranged toward the end of the cable to which the plug is connected and the other of which is configured to be arranged toward the opposite end of the cable.

28. The system of claim 27, wherein the two colored cuffs comprise the same color.
